(19) United States
(12) Patent Application Publication
(10) Pub. No.: US 2007/0012158 A1
(43) Pub. Date: Jan. 18, 2007

(54) String winding device for a stringed instrument

(76) Inventor: Han-soo Kang, Seoul (KR)

Correspondence Address: CANTOR COLBURN, LLP, 55 GRIFFIN ROAD SOUTH, BLOOMFIELD, CT, 06002, US

(21) Appl. No.: 11/187,372

(22) Filed: Jul. 22, 2005

(30) Foreign Application Priority Data
Jul. 12, 2005 (KR) 10-2005-0062796

(51) Int. Cl. G10D 3/14

(52) U.S. Cl. 84/304

(57) ABSTRACT

Disclosed is a string winding device for a stringed instrument in which the length of the winding shaft can be adjusted freely. The string winding device for a stringed instrument comprises a winding shaft 10 having a first insertion hole 11 inside; a fixed shaft 20, which is inserted into the first insertion hole 11 of the winding shaft 10 in such a way that it is possible to selectively slide along the first insertion hole 11 and having a second insertion hole 21 inside; a worm gear 30 installed at the lower end of the fixed shaft 20; and a fixing means 40, which is arranged in the second insertion hole 21 of the fixed shaft 20 in such a manner that it is possible to selectively release the fixed state of the winding shaft 10 with respect to the fixed shaft 20.

### BACKGROUND OT THE INVENTION

This application claims priority to Korean Patent Application No. 2005-62796, filed on Jul. 12, 2005, in the Korean Intellectual Property Office, the entire contents of which are hereby incorporated by reference.

1. Field of the Invention

The present invention relates to a string winding device for a stringed instrument, and more specifically to a string winding device for a stringed instrument in which the length of the winding shaft can be adjusted freely.

2. Description of the Related Art

As shown in FIG. 7, a plurality of the conventional string winding devices for stringed instrument are installed to a given height in the head portion H of the stringed instrument like a guitar. A plurality of strings S pass through the neck portion N of the stringed instrument and are inserted into a nut device ND fitted at the end of the neck portion N, and are fixed on a winding shaft 1 of the string winding device installed in the head portion H.

The process of adjusting the tensile strength of string S will be described using the string winding device. First, if the user rotates a tuning lever, a worm 3 arranged in a housing 2 is rotated to rotate a worm gear 4. Next, as the worm gear 4 is rotated, the winding shaft 1 fixed monolithically on the worm gear 4 is rotated, and accordingly, the string S connected to the winding shaft 1 is wound so as to adjust tensile strength.

At this time, a plurality of the winding shafts 1 installed in the head portion H have a given length respectively, so that the nut device ND and each of the strings S located between respective winding shafts 1 are installed with the angles maintained differently with respect to the head portion H.

Since the angles of the strings S are different each other, the pressing forces applied to the nut device ND while the string S is bent become different, respectively. Accordingly, in the string S, in which the pressing force applied to the nut device ND is small, the vibration energy by the nut device ND is not shut off smoothly.

Since the vibration energy of the string S is not shut off smoothly, the tonal quality of the string S becomes bad.

### SUMMARY OF THE INVENTION

Therefore, the present invention is designed to solve the problems of the prior art, and it is an object of the present invention to provide a string winding device for a stringed instrument, in which the length of the winding shaft can be adjusted freely.

Another object of the present invention is to provide a string winding device for a stringed instrument, in which the length of the winding shaft can be adjusted by simple operation without a separate tool.

Yet another object of the present invention is to provide a string winding device for a stringed instrument, in which the length of the winding shaft can be adjusted in multiple steps.

In accordance with the present invention, there is provided a string winding device for a stringed instrument wherein the length of string is adjusted by rotating a tuning lever having a worm formed at one end, comprising a winding shaft having a first insertion hole inside; a fixed shaft which is inserted into the first insertion hole of the winding shaft in such a way that it is possible to selectively slide along the first insertion hole and having a second insertion hole inside; a fixing means arranged in the second insertion hole of the fixed shaft in such a way that it is possible to selectively release the fixed state with respect to the fixed shaft; and a worm gear, which is fitted at the lower end of the fixed shaft in a state engaged with the worm, so that the rotatory force of the tuning lever transmitted through the worm is transmitted through the fixing means.

Preferably, the fixing means comprises a pushrod slidably arranged inside the second insertion hole and having a release slot on the upper end circumference; at least one through hole formed on the fixed shaft corresponding to the release slot; a fixed member slidably arranged in the through hole; and an elastic member which is arranged in the second insertion hole to elastically support the pushrod.

Preferably, the fixing means further comprises multi-step slots formed in plurality on the inner circumference of the insertion hole in such a way that one side of the fixed member is latched in multiple steps.

Preferably, the pushrod further comprises a fixed slot which is formed on the upper circumference of the release slot and has a fixed slot whose depth is relatively shallower than that of the release slot.

Preferably, the pushrod further comprises a latch tongue formed on the upper circumference of the support slot in such a way that it is latched on the topside of the fixed member.

Preferably, the fixed member is a metal ball arranged in the through hole.

Preferably, the elastic member is a coil spring arranged between the inside of the second insertion hole and the topside of the pushrod.

Preferably, the string winding device further comprises a retaining means that prevents the winding shaft separating from the fixed shaft.

Preferably, the retaining means comprises an inner tongue formed on the inner circumference of the insertion hole; and a latch portion arranged on the upper end circumference in such a way that it is latched onto the inner tongue.

Preferably, the latch portion includes a circular slot formed on the upper end circumference of the fixed shaft, and a retaining ring which is fitted in the circular slot and protruded outward of the fixed shaft.

### BRIEF DESCRIPTION OF THE DRAWINGS

The above and other features and advantages of the present invention will become more apparent by describing in detail exemplary embodiments thereof with reference to the attached drawings in which:

FIG. 1 is an exploded perspective view of a string winding device according to the preferred embodiment of the present invention;

FIG. 2 is a longitudinal sectional view of a string winding device according to the preferred embodiment of the present invention;

FIGS. 3 to 5 are longitudinal sectional views showing the operation of the string winding device according to the preferred embodiment of the present invention;

FIG. 6 is a longitudinal sectional view showing the installation state of the string winding device according to the preferred embodiment of the present invention;

FIG. 7 is a longitudinal sectional view showing the installation state of the conventional string winding device.

### DETAILED DESCRIPTION OF THE INVENTION

Exemplary embodiments according to the present invention will now be described in detail with reference to the accompanying drawings.

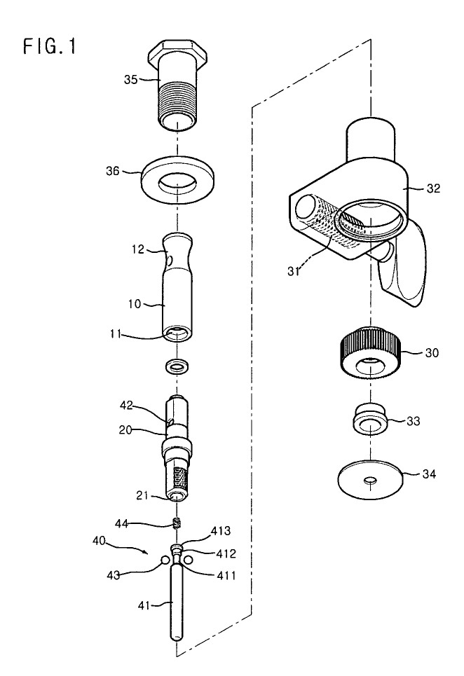

As shown in FIG. 1, in the string winding device for a stringed instrument like a guitar, for example, the length of the string is adjusted by rotating the tuning lever that has a worm 31 formed at one end of the stringed instrument. A string winding device for a stringed instrument according to the preferred embodiment of the present invention comprises a winding shaft 10 having a first insertion hole 11 inside; a fixed shaft 20, which is inserted into the first insertion hole 11 of the winding shaft 10 in such a way that it is possible to selectively slide along the first insertion hole 11 and having a second insertion hole 21 inside; a worm gear 30 installed at the lower end of the fixed shaft 20; and a fixing means 40, which is arranged in the second insertion hole 21 of the fixed shaft 20 in such a manner that it is possible to selectively release the fixed state of the winding shaft 10 with respect to the fixed shaft 20. Here, the worm gear 30 is fitted at the lower end of the fixed shaft 20 in a state engaged with the worm gear 31, and makes it possible to adjust the tensile strength of the string, by transmitting the rotatory force from the tuning lever transmitted through the worm 31 to the string through the fixing means 40.

The first insertion hole 11 is formed inside of the winding shaft 10. The fixed shaft 20 is arranged in the first insertion hole 11 of the winding shaft 10 in such a way that it can be slid up and down, so that it is possible to adjust the length of the winding shaft 10 even in such a state that the string is wound on the winding surface 12 formed in the upper portion of the winding shaft 10.

The fixed shaft 20, inserted in the first insertion hole 11 of the winding shaft 10, guides the winding shaft 10 in such a way that it can be slid up and down. The second insertion hole 21 is formed vertically toward the top from the lower end of the fixed shaft 20 and is the space for installing the fixing means 40.

The worm gear 30 is arranged inside of the housing 32 in a state engaged with the worm 31 and screwed to the lower end of the fixed shaft 20. At this time, part of the lower portion of the fixed shaft 20 having a male screw formed on is formed in a flat surface and also on the inside of the worm gear 30 is formed a flat surface (not shown) corresponding to the flat surface of the fixed shaft 20. Accordingly, during assembly, the worm gear 30 can be moved lengthwise along the fixed shaft 20 to be arranged in a desired place. But, after assembly is completed, the movement of the worm gear 30 in radial direction is obstructed by these flat surfaces, so it is possible to transmit the user's operating force transmitted from the tuning lever through the worm 31, through the fixed shaft 20 to the fixing means 40.

A fixed nut 33 is screwed to the male screw formed at the lower end of the fixed shaft 20 so as to prevent the worm gear 30 from separating from the fixed shaft 20.

An open portion is formed on the bottom surface of the housing 32 for assembly and disassembly of the worm gear 30 and the fixed nut 33, and a cover 34 is fitted on this open portion. A bush 35 is screwed to the inner circumference of the top of the housing 32, and into the outer circumference of the bush 35 is inserted a washer 35 for prevention of separating.

The fixing means 40 is arranged in the second insertion hole 21 of the fixed shaft 20 in such a way that the fixed state of the winding shaft 10 can be selectively released with respect to the fixed shaft 20. Accordingly, in a state in which the winding shaft 10 is fixed on the fixed shaft 20, if it is necessary to adjust the length of the winding shaft 10, the fixed state of the winding shaft 10 with respect to the fixed shaft 20 can be released by using the fixing means 40.

The fixing means 40 that plays such a role comprises a pushrod 41 which is slidably arranged on the inside of the second insertion hole 21; at least one through hole 42 which is formed on the fixed shaft 20 corresponding to a release slot 411 formed on the outer circumference of the pushrod 41; a fixed member 43 which is slidably arranged in the through hole 41; and an elastic member 44 which is arranged in the second insertion hole 21 to support the pushrod 41 elastically.

The upper end of the pushrod 41 is arranged on the inside of the second insertion hole 21 and the lower end of the pushrod 41 is extended to the outside of the housing 32 through the cover 34. Accordingly, the user can operate by pressing the lower end of the pushrod 41.

At the upper end of the pushrod is formed a release slot 411, and at the upper portion of this release slot 411 is formed a fixed slot 412, and at the upper end of this fixed slot 412 is formed a latch tongue 413. The release slot 411 plays the role of releasing the pressed state of the fixed member 43, and the fixed slot 412 plays the role of pressing the fixed member 43 to one side, and the latch tongue 413 plays the role of the pushrod 41 to be latched onto the topside of the fixed member 43 to prevent separating.

The through hole 42 provides a space for the fixed member 43 to be slidably arranged in a state corresponding to the inside of the first insertion hole 11.

The fixed member 43 is slid along the through hole 42 by the release slot 411 and the fixed slot 412 according to the operation of the pushrod 41, and accordingly comes in contact with or separates from the inside of the first insertion hole 11 of the winding shaft 10 to fix or release the winding shaft 10 to or from the fixed shaft 20. The fixed member 43 that plays such a role is preferably made of a metal ball arranged in the through hole 42.

The elastic member 44 plays the role of maintaining the pushrod 41 in a pressed state by elastic force or returning to the original position after the pushrod is operated by the user. The elastic member 44 that plays such a role is preferably made of a coil spring arranged between the inside of the second insertion hole 21 of the fixed shaft 20 and the topside of the pushrod 41.

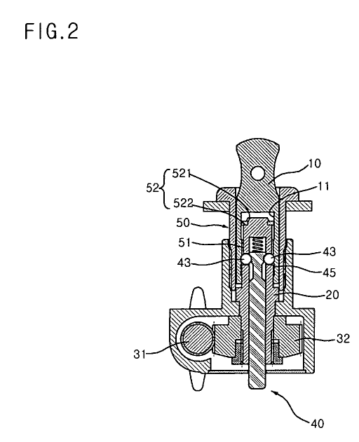

As shown in FIG. 2, the fixing means 40 further comprises multi-step slots 45 formed in plurality on the inner circumference of the first insertion hole 11 such that one side of the fixed member 43 is latched in multiple steps. The multi-step slots 45 enable the length of the winding shaft 10 to be adjusted in multiple steps.

If the worm 31 is rotated in a state in which the fixed member 43 comes in close contact with the multi-step slots 45 and the winding shaft 10 is fixed to the fixed shaft 20, the worm gear 30 engaged with the worm 31 is rotated to rotate the fixed shaft 20, and accordingly, the winding shaft 10 fixed on the fixed shaft 20 is rotated to wind the string.

The string winding device for a stringed instrument according to the preferable embodiment of the present invention further comprises a retaining means 50 that prevents the winding shaft 10 from separating from the fixed shaft 20.

The retaining means 50 prevents the winding shaft 10 from separating from the fixed shaft 10, so that it is possible to stably adjust the length of the fixed shaft 20.

The retaining means 50 playing such a role comprises an inner tongue 51 formed on the inner circumference of the first insertion hole 11 of the winding shaft 50, and a stopper 52 arranged on the upper end circumference of the fixed shaft 20 so as to be latched onto the inner tongue 51. And, the stopper 52 comprises a circular slot 521 formed on the upper end circumference of the fixed shaft 20, and a retaining ring 522 fitted on the circular slot 521 and protruded outward of the fixed shaft 20.

The retaining means 50 makes the retaining ring 522 latch onto the inner tongue 51 so as to prevent the winding shaft 10 from separating from the fixed shaft 20.

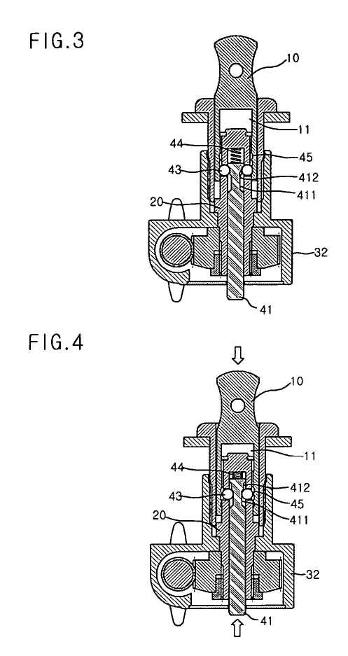

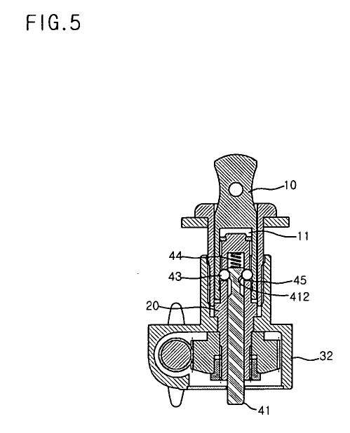

As shown in FIG. 3, FIG. 4 and FIG. 5, if the user wants to adjust the length of the winding shaft 10, he presses the lower end of the pushrod 41 exposed downward of the housing 32.

If the pushrod 41 is pushed to be slid upward, the elastic member 44 is pressed while the fixed member 43 that was in contact with the fixed slot 412 is inserted into the release slot 411, and accordingly the adherent force with respect to the inside of the first insertion hole 11 of the winding shaft 10 is removed by the fixed member 43.

While the pushrod 41 is pushed like this to release the fixed state of the winding shaft 10 with respect to the fixed shaft 20, the user can push the winding shaft 10 to adjust the length thereof.

And, if the user lets go the pushrod 41 that he was pushing after the adjustment of the length is completed by pushing the winding shaft 10, the pushrod 41 is returned to the initial state by the elastic member 44 while the fixed slot 412 presses the fixed member 43 outward so that the fixed member 43 comes in close contact with the inside of the first insertion hole 11 of the winding shaft 10.

When the fixed member 43 comes in close contact with the inside of the first insertion hole 11, the winding shaft 10 is fixed on the fixed shaft 20.

At this time, the fixed member 43 comes in close contact with any one of the multi-step slots 45 formed on the inside of the first insertion hole 11, so that the length of the winding shaft 10 is adjusted at a given rate.

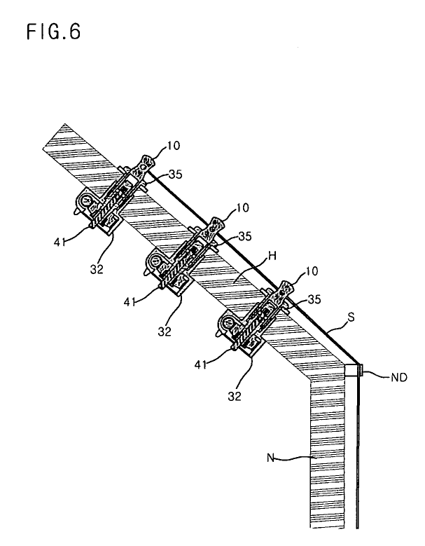

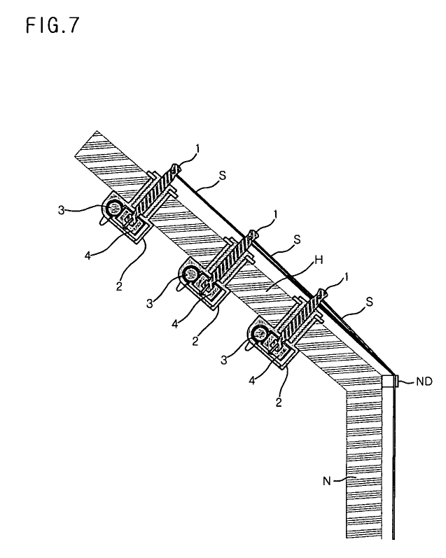

As shown in FIG. 6, a plurality of the string winding devices according to the preferred embodiment of the present invention are installed on the head portion H of stringed instrument by screwing the housing 32 and the bush 35. With the string winding devices installed on the head portion H like this, the string S extended through the nut device ND of the neck portion N is fixed on the winding shaft 10.

And, the user operates the pushrod 41 and the winding shaft 10 to adjust the protruded length of the winding shaft 10, so that the string S located between the nut device ND and each winding shaft 10 gets a uniform angle with respect to the head portion H.

As mentioned above, the present invention makes it possible to adjust the length of the winding shaft freely, so the angle of each string with respect to the head of the stringed instrument can be made uniform and the pressing force applied to the nut by each string can be adjusted for a good quality of tone.

Also, the present invention makes it possible to adjust the length of the winding shaft by simple operation without a separate tool, convenience of use is enhanced and adjustment of tone becomes possible in a short time.

Also, the present invention makes it possible to adjust the length of the winding shaft in multiple steps, so convenience of use is enhanced and length adjustment of winding shaft is made accurately at a given rate.

While the present invention has been described with reference to exemplary embodiments thereof, it will be understood by those skilled in the art that various changes in form and details may be made therein without departing from the scope of the present invention as defined by the following claims.

What is claimed is:

1. A string winding device for a stringed instrument wherein the length of string is adjusted by rotating a tuning lever having a worm formed at one end, comprising:
a winding shaft having a first insertion hole inside;
a fixed shaft which is inserted into the first insertion hole of the winding shaft in such a way that it is possible to selectively slide along the first insertion hole and having a second insertion hole inside;
a fixing means arranged in the second insertion hole of the fixed shaft in such a way that it is possible to selectively release the fixed state with respect to the fixed shaft; and
a worm gear, which is fitted at the lower end of the fixed shaft in a state engaged with the worm, so that the rotatory force of the tuning lever transmitted through the worm is transmitted through the fixing means.

2. The string winding device of claim 1, wherein the fixing means comprises,
a pushrod slidably arranged inside the second insertion hole and having a release slot on the upper end circumference;
at least one through hole formed on the fixed shaft corresponding to the release slot;
a fixed member slidably arranged in the through hole; and
an elastic member which is arranged in the second insertion hole to elastically support the pushrod.

3. The string winding device of claim 2, wherein the fixing means further comprises multi-step slots formed in plurality on the inner circumference of the insertion hole in such a way that one side of the fixed member is latched in multiple steps.

4. The string winding device of claim 2, wherein the pushrod further comprises a fixed slot which is formed on the upper circumference of the release slot and has a fixed slot whose depth is relatively shallower than that of the release slot.

5. The string winding device of claim 4, wherein the pushrod further comprises a latch tongue formed on the upper circumference of the support slot in such a way that it is latched on the topside of the fixed member.

6. The string winding device of claim 2, wherein the fixed member is a metal ball arranged in the through hole.

7. The string winding device of claim 2, wherein the elastic member is a coil spring arranged between the inside of the second insertion hole and the topside of the pushrod.

8. The string winding device of claim 1, further comprising a retaining means that prevents the winding shaft separating from the fixed shaft.

9. The string winding device of claim 8, wherein the retaining means comprises,
an inner tongue formed on the inner circumference of the insertion hole; and
a latch portion arranged on the upper end circumference in such a way that it is latched onto the inner tongue.

10. The string winding device of claim 9, wherein the latch portion includes,
a circular slot formed on the upper end circumference of the fixed shaft, and
a retaining ring which is fitted in the circular slot and protruded outward of the fixed shaft.
